(19) United States
(12) Patent Application Publication
(10) Pub. No.: US 2024/0287657 A1
(43) Pub. Date: Aug. 29, 2024

(54) Dual Phase High Entropy Boride-Carbide Composites for Extreme Environments

(71) Applicant: The Government of the United States of America, as represented by the Secretary of the Navy, Arlington, VA (US)

(72) Inventors: Ramasis Goswami, Alexandria, VA (US); Alex E. Moser, Fort Washington, MD (US)

(73) Assignee: The Government of the United States of America, as represented by the Secretary of the Navy, Arlington, VA (US)

(21) Appl. No.: 18/443,995

(22) Filed: Feb. 16, 2024

Related U.S. Application Data
(60) Provisional application No. 63/449,048, filed on Feb. 28, 2023.

(51) Int. Cl. C22C 29/08; B22F 9/04; C22C 1/051; C22C 29/06

(52) U.S. Cl. CPC C22C 29/08; B22F 9/04; C22C 1/051; C22C 29/067; B22F 2009/044

(57) ABSTRACT

A dual phase high entropy boride-carbide composite for extreme environments, comprising dual phases of high entropy boride (HEB) and high entropy carbide (HEC), wherein the high entropy boride comprises (Zr—Hf—Ti—V)B₂ and wherein the high entropy carbide comprises (Zr—Hf—Ti—V)C. A method of making a dual phase high entropy boride-carbide composite for extreme environments, comprising the steps of utilizing a pressureless reactive sintering process, providing a Zr—Hf—Ti—V—B₄C powder blend, maintaining a low sintering temperature, allowing the Zr—Hf—Ti—V—B₄C powder blend to result in HE-Alloy powder and B₄C, allowing the B₄C to result in 4B and C and heat, reacting the HE-Alloy powder with the B and the C, and forming a HE-boride composite and a HE-carbide composite, wherein the HE-boride composite and HE-carbide composite comprise (Zr—Hf—Ti—V)B₂+(Zr—Hf—Ti—V)C.

### REFERENCE TO RELATED APPLICATION

This application is a non-provisional of, and claims priority to and the benefits of, U.S. Provisional Patent Application No. 63/449,048 filed on Mar. 1, 2023, the entirety of which is herein incorporated by reference.

### BACKGROUND

This disclosure demonstrates a novel ceramic matrix composite, containing dual phases of high entropy boride (HEB) and high entropy carbide (HEC) for the purpose of advancing the current limitations on leading edge materials in military hypersonic and reentry vehicles.

Here we utilize the pressureless reactive sintering process to manufacture a high entropy composite, containing (Zr—Hf—Ti—V)B₂+(Zr—Hf—Ti—V)C, from a Zr—Hf—Ti—V—B₄C powder blend at relatively low sintering temperatures.

This provides a novel and alternative method of developing high-strength-ultra high temperature composites, which are very useful for hypersonic-leading edge structures for future hypersonic military vehicles over the established hypersonic materials.

Our dual phase high entropy boride-carbide composites for extreme environments solves long-standing problems in the art.

For example, considerable effort has been made in the prior art to address thermal protection in hypersonic vehicles—for military structural components, and aerospace applications. For thermal protection, materials systems requirements include materials exhibiting high strength at elevated temperatures, high oxidation tolerance, and high thermal conductivity. The transition metal borides and carbides, such as ZrB₂, ZrC, HfB₂, HfC and their combinations have emerged as promising candidates for ultrahigh temperature ceramics (UHTCs). These are considered to be the major components in today's military hypersonic vehicle warfare systems, as these ceramics have a unique combination of properties, such as high electrical and thermal conductivity and chemical inertness. In some cases, carbon fiber reinforced ZrC and carbon-carbon (C—C) composites have also been employed.

However, a major concern and long-standing problem of the prior art UHTCs has been their poor sinterability due to strong covalent bonding. Additionally, UHTCs have poor mechanical properties and poor oxidation tolerance at elevated temperatures.

Furthermore, another long-standing problem of the prior art is that for C—C and carbon fiber reinforced composites, C-fiber related composites exhibit high ablation behavior at elevated temperature. The poor high temperature strength and poor oxidation tolerance for ZrB₂-based ceramics causes the initiation of failure. This limits operating velocities and degrades system reliability.

Inadequate mechanical properties and oxidation tolerance, and poor sintering ability to a near-net form present serious roadblocks to accessing the full capabilities and performance of ZrB₂-based ceramics and hinder advances in next generation hypersonic materials. To this end, previous research efforts on Zr-diborides-SiC based materials show improvement in mechanical properties and oxidation resistance through the addition of appropriate additives. Researchers found that Si compounds, such as SiC and metal silicides, are suitable additives to increase oxidation resistance and mechanical properties.

However, it was realized ZrB₂—SiC based samples synthesized in the bulk are not commercially viable using the traditional sintering and processing methods as it requires long consolidation times at elevated temperatures, show moderate mechanical properties, and are considered to be the major roadblock.

The addition of Si also reduces the operating temperature from 2400° C. to 1700° C. To reduce the consolidation temperature the pressureless reactive sintering process has been used to synthesize (Zr—Hf)B₂+SiC composite.

Recently, researchers have reported the enhanced oxidation tolerance and strength of the transition metal based high entropy borides and high entropy carbides. These studies have demonstrated the synthesis of a series of (Ti—Zr—Hf—Nb—Ta)B₂ high entropy borides (HEBs) and the (Ti—Zr—Hf—Nb—Ta)C high entropy carbides (HECs) using spark plasma sintering (SPS) process at temperatures greater than 1900° C. They have used individual transition metal borides or carbides and formed a blend of borides or carbides with ball milling, and then heated them up to form high entropy borides and carbides.

However, the major limitation of the prior art manufacturing process is that they may not form a single lattice of boride or carbide.

The prior art produces merely a mechanical mixture of nanocrystalline borides or carbides.

To solve these prior art issues of high entropy alloying as well as lower consolidation or sintering temperatures, we have utilized a different approach.

Here, the transition-metal based high entropy boride and high entropy carbide has been synthesized from a powder blend of Zr, Hf, Ti, V, and B₄C instead of the blend on individual binary borides or carbides.

We herein use a pressureless reactive-sintering process at 1500° C.

In our process, initially, alloying of metallic powder occurs during heating the blend in furnace in an inert atmosphere.

The high entropy boride as well as the high entropy carbide grains form when B₄C dissociates into B and C.

Here, we demonstrate the first synthesis of a composite containing mostly a high-entropy boride and high entropy carbide of Zr—Hf—Ti—V using the pressureless reactive sintering method.

### SUMMARY OF DISCLOSURE

### Description

This disclosure demonstrates a novel ceramic matrix composite, containing dual phases of high entropy boride (HEB) and high entropy carbide (HEC) for the purpose of advancing the current limitations on leading edge materials in military hypersonic and reentry vehicles.

Here we utilize the pressureless reactive sintering process to manufacture a high entropy composite, containing (Zr—Hf—Ti—V)B₂+(Zr—Hf—Ti—V)C, from a Zr—Hf—Ti—V—B₄C powder blend at relatively low sintering temperatures.

This provides a novel and alternative method of developing high-strength-ultra high temperature composites, which are very useful for hypersonic-leading edge structures for future hypersonic military vehicles over the established hypersonic materials.

### DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings.

FIG. 1 illustrates the XRD of the powder mixtures and the composite. Shown is the XRD after the conversion of the green pallet, showing the high entropy carbide and high entropy boride phase. The major phases are carbide with cubic structure and borides with hexagonal structure. Also shown is a high entropy oxide phase. Illustrated is an XRD from the green compact containing the blend of Zr, Hf, Ti, V and B₄C powder. In this case, the ratio of powder mixture by weight is 4:2:2:1:2.

FIG. 2 illustrates multibeam low magnification TEM images showing the fine scale microstructure of the portion of the powder particles. A number of grains or interfaces are observed.

FIG. 3 illustrates a fine probe EDS obtained from the portion of a particle containing Zr, Hf, Ti and V.

FIG. 4 illustrates a low magnification TEM image showing the boundary between two grains and an HRTEM image showing the bottom grain is a cubic carbide phase, close to 11-2 zone with 111 and 2-20 lattice planes and the top one is a boride phase showing 10-10 lattice planes. The FFTs are shown an as inset.

FIG. 5 illustrates a low magnification TEM image showing the faceted cubic carbide phase and an HRTEM image showing the bottom grain is a cubic phase, close to 1-10 zone with 111 and 002 lattice planes. Also illustrated is the faceted growth of the carbide phase.

FIG. 6 illustrates a low magnification TEM image showing high fault density associated with the boride phase. Also illustrated is a HRTEM image showing the faults. The fault plane is 10-10.

FIG. 7 illustrates the interaction of the sintered specimen with an oxyacetylene flame.

FIG. 8 illustrates load vs penetration curves during nanoindentation of the carbide phase. The average hardness is 37.1 GPa.

### DETAILED DESCRIPTION OF THE INVENTION

This disclosure demonstrates a novel ceramic matrix composite, containing dual phases of high entropy boride (HEB) and high entropy carbide (HEC) for the purpose of advancing the current limitations on leading edge materials in military hypersonic and reentry vehicles.

Here we utilize the pressureless reactive sintering process to manufacture a high entropy composite, containing (Zr—Hf—Ti—V)B₂+(Zr—Hf—Ti—V)C, from a Zr—Hf—Ti—V—B₄C powder blend at relatively low sintering temperatures.

This provides a novel and alternative method of developing high-strength-ultra high temperature composites, which are very useful for hypersonic-leading edge structures for future hypersonic military vehicles over the established hypersonic materials.

### Example 1

High energy ball milling was performed using a SPEX 8000M Mixer/Mill for approximately 30 minutes at room temperature with an initial mixture of B₄C, Zr, Hf, Ti and V powders.

The powders of Zr, Hf, Ti, V and B₄C were added in the ratio of 4:2:2:1:2.

Initially, we made green compacts under pressure (˜1.0 GPa) with milled powder mixtures.

### Example 2

For the pressureless sintering process, the green compacts were transferred to box furnace and then heated to 1500° C. under the dynamic Ar atmosphere.

For the full conversion process, the green compacts were kept at 1500° C. for around 8 h under the dynamic Ar atmosphere.

The pressureless sintering process is described below.

### Example 3

During heating, the green compacts transform to high entropy alloy powder and then reacts with B₄C, which decomposed in an exothermic reaction to release B and C.

The dual phase boride-carbide forms according to the following reaction:

Zr,Hf,Ti,V→HE-alloy (Zr—Hf—Ti,V), 1.

B₄C→4B+C+heat release, 2.

2(Zr—Hf—Ti—V)+2B+C→(Zr—Hf—Ti—V)B₂+(Zr—Hf—Ti—V)C 3.

### Example 4

Composites were subsequently characterized by x-ray diffraction (XRD) using a Rigaku 18 kW x-ray generator and a high-resolution powder diffractometer utilizing a Cu-Kα₁ radiation. For transmission electron microscopy (TEM) and high-resolution TEM (HRTEM) observations, a part of the sample was initially crushed in alcohol and transferred into a c-coated Cu grid. A JEOL-2200FX analytical transmission electron microscope operated at 200 keV was then used to investigate the interface and fine scale microstructure of the composites. An optical microscopy was used to characterize microstructure of the composites in macro scale.

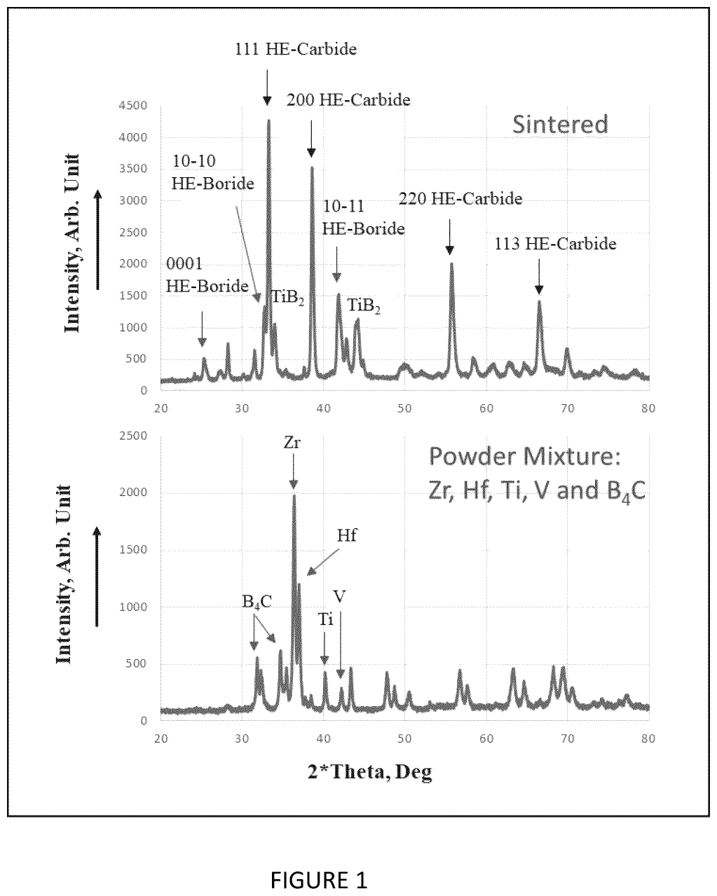

FIG. 1 shows the x-ray diffraction (XRD) of the powder mixtures and the composite, respectively. The XRD after the conversion of the green pallet, showing the high entropy carbide and high entropy boride phases, is illustrated in FIG. 1. The XRD from the green compact containing the blend of Zr, Hf, Ti, V and B₄C powder is also shown in FIG. 1.

After the conversion, the major phases are carbide with cubic structure and borides with hexagonal structure.

Also observed is a high entropy oxide phase.

After the conversion, no peak corresponding to B₄C was observed, suggesting the complete dissociation of B₄C and the formation of boride and carbide.

### Example 5

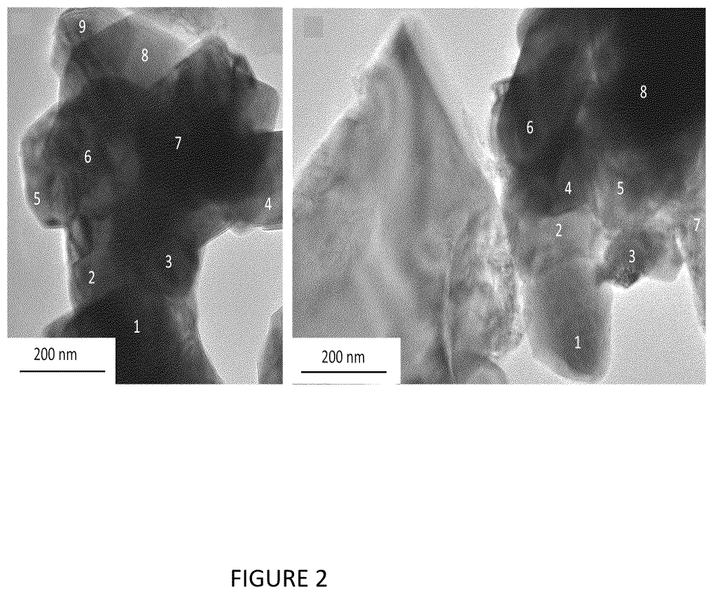

FIG. 2 illustrates the multibeam low magnification transmission electron microscopic (TEM) images after the conversion showing the fine scale microstructure of the portion of the powder particle. A number of fine grains, indicated as 1 to 9, grain boundaries or interfaces are observed and illustrated.

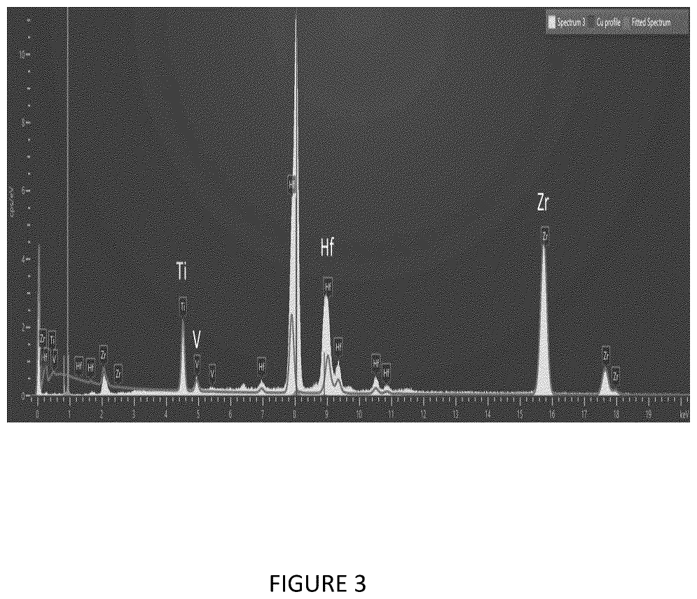

A fine probe EDS data was obtained from the portion of a particle (FIG. 3) showing the particle containing Zr, Hf, Ti, and V.

### Example 6

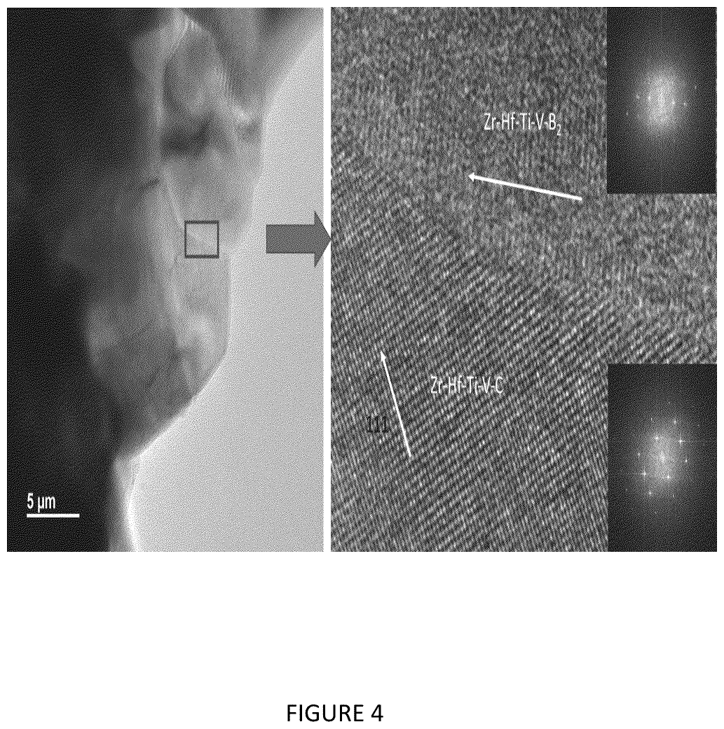

FIG. 4 illustrates a low magnification TEM image showing the boundary between two grains. The corresponding high-resolution TEM (HRTEM) image shows the bottom grain is a cubic carbide phase, close to 11-2 zone with 111 and 2-20 lattice planes, and the top one is a boride phase showing 10-10 lattice planes. The corresponding fast Fourier transforms (FFTs) are shown an as inset.

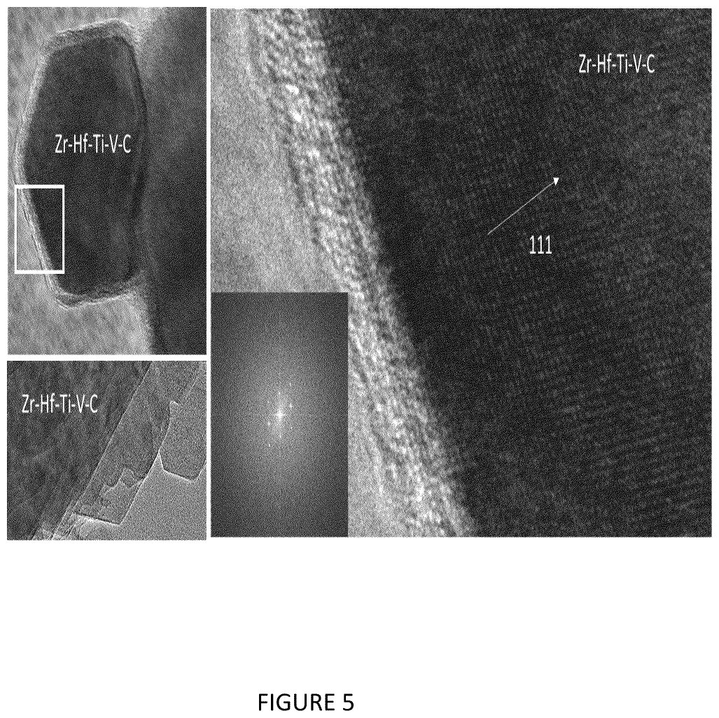

A low magnification TEM image showing the faceted cubic carbide phase is illustrated in FIG. 5.

The HRTEM image of FIG. 5 shows the grain is a cubic phase, close to 1-10 zone with 111 and 002 lattice planes.

The faceted growth of the carbide phase is also shown in FIG. 5.

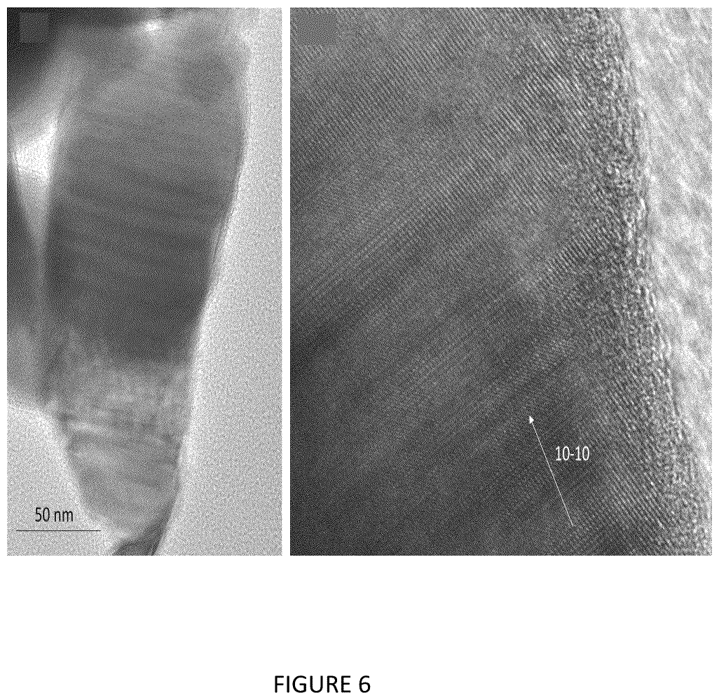

FIG. 6 is a low magnification TEM image showing the high fault density associated with the boride phase. The corresponding HRTEM image of FIG. 6 shows the faults. The fault plane is 10-10.

### Example 7

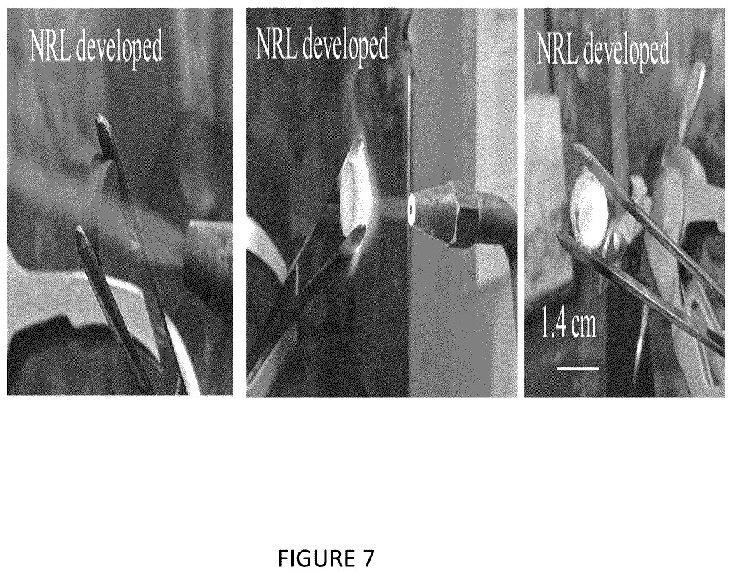

We conducted oxyacetylene torch testing to understand whether the ceramic materials will survive severe conditions (FIG. 7).

The oxidation performance has been assessed by the weight change at elevated temperatures. The oxyacetylene testing was carried out with an exposure time of 1 min. The estimated flame temperature is 2700° C., and the estimated weight gain due to oxidation is 0.3 gm cm⁻² min⁻¹.

Samples survived severe conditions associated with hypersonic flight and reentry vehicles, demonstrating the ability to withstand thermal shock.

To investigate the mechanical behavior, micro indentation hardness tests were performed using nanoindentation hardness measurements at 20 mN force using a Berkovich indenter.

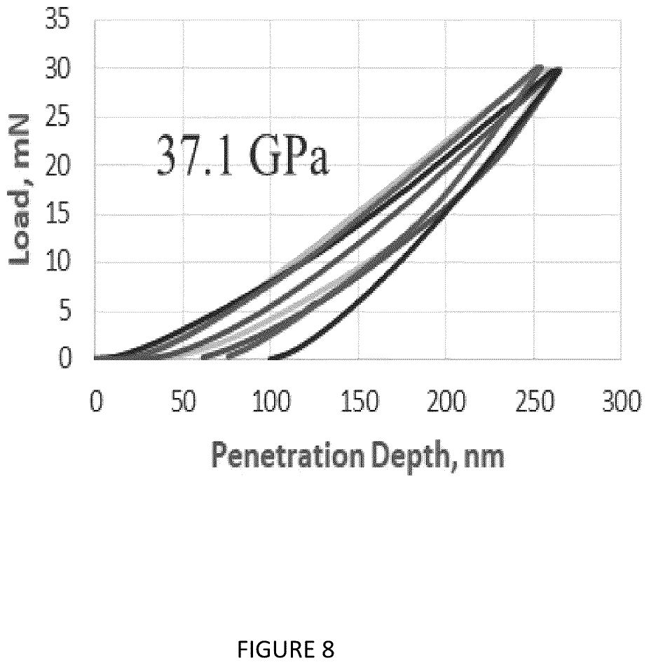

FIG. 8 illustrates the load vs penetration curves during nanoindentation of the carbide phase. The average hardness is 37.1 GPa.

We demonstrated the composite, containing high entropy boride and high entropy carbide of Zr—Hf—Ti—V at relatively lower temperature using a pressureless reactive-sintering process.

The reactive process develops a high entropy single boride as well as carbide lattice grains and helps sinter the composite at a relatively lower temperature.

### Advantages

Our approach described herein will facilitate the sintering process at relatively low temperatures and is a highly scalable process for producing large quantities.

In addition, the composite has a dual-phase instead of a single-phase boride or carbide, resulting in higher oxidation tolerance and higher strength, thus solving long-standing problems in the prior art.

Furthermore, other composites, for example, composites containing (Ti—Zr—Hf—Nb—Ta)B₂ high entropy borides (HEBs) and (Ti—Zr—Hf—Nb—Ta)C high entropy carbides with different elemental ratio can be synthesized using our process. Elemental ranges in atom fraction: 7.

Additionally (A-X—Y—Z-D-E)B₂ where A, X, Y, Z, and D have a range between 0.2 to 0.4 and E has a range between 0 and 0.4, and A, X, Y, Z, and D from the periodic table refractory transition metal groups IVB through VIB (Ti, Zr, Hf, Rf, V, Nb, Ta, Cr, Mo, W). Also, (A-X—Y—Z-D-E)C where A, X, Y, Z, and D have a range between 0.2 to 0.4 and E has a range between 0 and 0.4 from the periodic table refractory transition metal groups IVB through VIB (Ti, Zr, Hf, Rf, V, Nb, Ta, Cr, Mo, W).

To summarize, we demonstrated the composite, containing high entropy boride and high entropy carbide of Zr—Hf—Ti—V at relatively lower temperature using a pressureless reactive-sintering process.

The reactive process develops a high entropy single boride as well as carbide lattice grains and helps sinter the composite at a relatively lower temperature.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

What we claim is:

1. A dual phase high entropy boride-carbide composite for extreme environments, comprising:
dual phases of high entropy boride (HEB) and high entropy carbide (HEC);
wherein the high entropy boride comprises (Zr—Hf—Ti—V)B₂; and
wherein the high entropy carbide comprises (Zr—Hf—Ti—V)C.

2. The dual phase high entropy boride-carbide composite for extreme environments of claim 1,
wherein the dual phase high entropy boride (HEB) and high entropy carbide (HEC) composite has a hardness of 37 GPa.

3. The dual phase high entropy boride-carbide composite for extreme environments of claim 2,
wherein the high entropy carbide comprises a cubic structure; and
wherein the high entropy boride comprises a hexagonal structure.

4. The dual phase high entropy boride-carbide composite for extreme environments of claim 3,
wherein the dual phase high entropy boride (HEB) and high entropy carbide (HEC) composite is formed from a Zr—Hf—Ti—V—B₄C powder blend at relatively low sintering temperatures.

5. A method of making a dual phase high entropy boride-carbide composite for extreme environments, comprising the steps of:
utilizing a pressureless reactive sintering process;
providing a Zr—Hf—Ti—V—B₄C powder blend;
maintaining a low sintering temperature;
allowing the Zr—Hf—Ti—V—B₄C powder blend to result in HE-Alloy powder and B₄C;
allowing the B₄C to result in 4B and C and heat;
reacting the HE-Alloy powder with the B and the C; and
forming a HE-boride composite and a HE-carbide composite;
wherein the HE-boride composite and HE-carbide composite comprise (Zr—Hf—Ti—V)B₂+(Zr—Hf—Ti—V)C.

6. The method of making a dual phase high entropy boride-carbide composite for extreme environments of claim 5,
wherein the dual phase HE-boride (HEB) and HE-carbide (HEC) composite has a hardness of 37 GPa.

7. The method of making a dual phase high entropy boride-carbide composite for extreme environments of claim 6,
wherein the high entropy carbide comprises a cubic structure; and
wherein the high entropy boride comprises a hexagonal structure.

8. A method of making a dual phase high entropy boride-carbide composite for extreme environments, comprising the steps of:
providing an initial mixture of B₄C, Zr, Hf, Ti and V powders;
wherein the ratio of Zr, Hf, Ti, V and B₄C are in the ratio of 4:2:2:1:2;
performing high energy ball milling using a SPEX 8000M Mixer/Mill;
making green compacts under pressure;
transferring the green compacts to a box furnace for pressureless sintering;
heating the box furnace to 1500° C. under a dynamic Ar atmosphere;
maintaining 1500° C. under the dynamic Ar atmosphere;
transforming the green compacts to high entropy powder;
decomposing the B₄C to in an exothermic reaction to release B and C;
reacting the high entropy powder with the B and the C; and
forming a dual phase high entropy boride-carbide composite.

9. The method of making a dual phase high entropy boride-carbide composite for extreme environments of claim 8,
wherein the dual phase high entropy boride-carbide composite has a hardness of 37 GPa.

10. The method of making a dual phase high entropy boride-carbide composite for extreme environments of claim 8,
wherein the high entropy carbide comprises a cubic structure; and
wherein the high entropy boride comprises a hexagonal structure.

11. The method of making a dual phase high entropy boride-carbide composite for extreme environments of claim 10, further comprising the steps of:
performing the step of performing high energy ball milling using a SPEX 8000M Mixer/Mill for approximately 30 minutes at room temperature; and
maintaining the step of maintaining 1500° C. for around 8 hours under the dynamic Ar atmosphere.

12. The method of making a dual phase high entropy boride-carbide composite for extreme environments of claim 11,
wherein the pressure during the step of making green compacts under pressure is about 1.0 GPa.

13. The method of making a dual phase high entropy boride-carbide composite for extreme environments of claim 12,
wherein the pressureless sintering involves atmospheric pressure or no added pressure or no pressure added to the box furnace.

14. A dual phase high entropy boride-carbide composite for extreme environments, comprising:
dual phases of high entropy boride (HEB) and high entropy carbide (HEC);
wherein the high entropy boride comprises (A-X—Y—Z-D-E)B₂ where A, X, Y, Z, and D have a range between 0.2 to 0.4 and E has a range between 0 and 0.4, and A, X, Y, Z, and D are from the periodic table refractory transition metal groups IVB through VIB comprising Ti, Zr, Hf, Rf, V, Nb, Ta, Cr, Mo, W; and
wherein the high entropy carbide comprises (A-X—Y—Z-D-E)C where A, X, Y, Z, and D have a range between 0.2 to 0.4 and E has a range between 0 and 0.4, and A, X, Y, Z, and D are from the periodic table refractory transition metal groups IVB through VIB comprising Ti, Zr, Hf, Rf, V, Nb, Ta, Cr, Mo, W.
